(19) United States
(12) Patent Application Publication
(10) Pub. No.: US 2005/0102777 A1
(43) Pub. Date: May 19, 2005

(54) Unit and arrangement for the treatment of vehicles, where an integrated unit is used

(76) Inventor: Leif Johansson, Norrkoping (SE)

Correspondence Address: VENABLE, BAETJER, HOWARD AND CIVILETTI, LLP, P.O. BOX 34385, WASHINGTON, DC, 20043-9998, US

(21) Appl. No.: 10/502,778

(22) PCT Filed: Jan. 27, 2003
(86) PCT No.: PCT/SE03/00135

(30) Foreign Application Priority Data
Jan. 28, 2002 (SE) 0200246-7

(51) Int. Cl. B08B 3/04

(52) U.S. Cl. 15/53.1; 134/123

(57) ABSTRACT

Method, aggregate and vehicle wash equipment to with at least one fluid jet remove from an exterior surface of a vehicle (F) solid and liquid particles and where appropriate also increase the lustre of the surface, where the jet is brought to move along the surface during simultaneous exercise of a substantially horizontal oscillating movement.

The present invention relates to an aggregate according to the preamble of claim 1.

The invention also relates to a vehicle washing establishment according to the preamble of claim 5.

The most common vehicle washing equipments of today are automatic, where the vehicle is driven into and parked in a car wash. Brushes and/or high-pressure washes are arranged on a portal, which runs on each side of the vehicle In tracks, which are arranged on the floor in the car wash. However, when washing in these car washes blind angles cannot be reached, so called wash and dry shadows such as e.g. behind the rear view mirrors. Additionally, the vehicles will not be cleanst where they are the dirtiest, i.e. in the middle of, just below and over the bumpers.

Further, the car washes of today are complicated to manufacture, to transport and to assemble in place. There have even been personal injuries, even deaths, due to the risk of being squeezed between e.g. the vehicle and the machine portal.

EP 829 400 discloses a drying device for a car wash, which is moved around the vehicle that shall be washed and which is turnable in order to be perpendicular against the surface of the vehicle all the time. This device comes close to the vehicle when drying and thus obtains a good drying result, but still there remains drying shadows that cannot be reached with the device.

Thus, there is a need for a car wash that improves the washing, flushing, vaxing and drying result all around the body of the vehicle, i.e. a relatively simple kind of equipment, that effectively prevents injuries on persons and damages on objects at use.

One object of the present invention is to accomplish a simplified and improved aggregate according to the preamble of claim 1 as well as a simplified and improved equipment according to the preamble of claim 5. This Is obtained by the inventive aggregate with the characteristic features apparent from the characteristic part of claim 1. The characteristic features of the inventive equipment are apparent from the characteristic part of claim 5.

With use of the invention the aggregate and the equipment according to the invention have the features mentioned in the characteristic part of claims 2-4 and 6-7 respectively.

The invention will in the following be explained more in detail referring to the attached drawing on which:

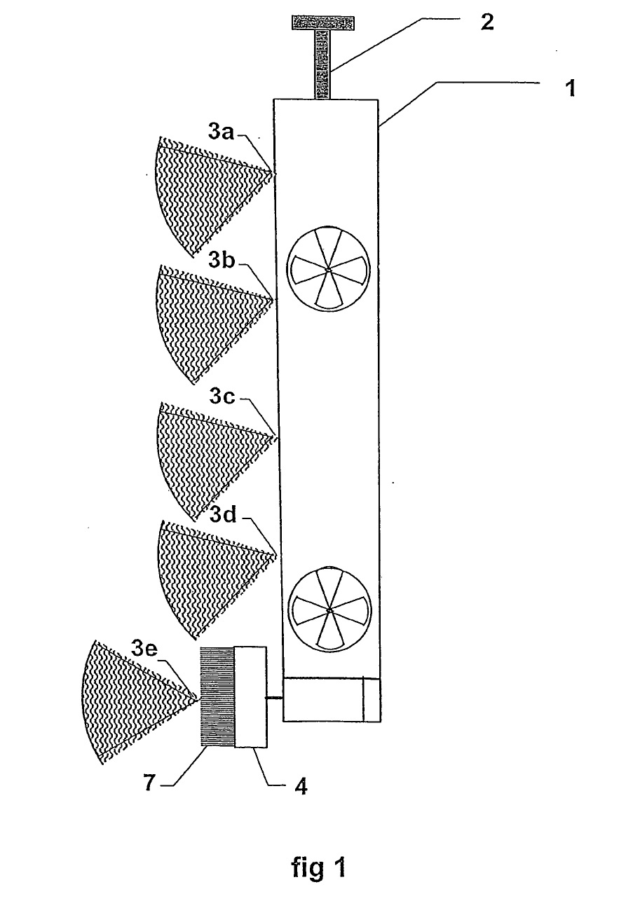

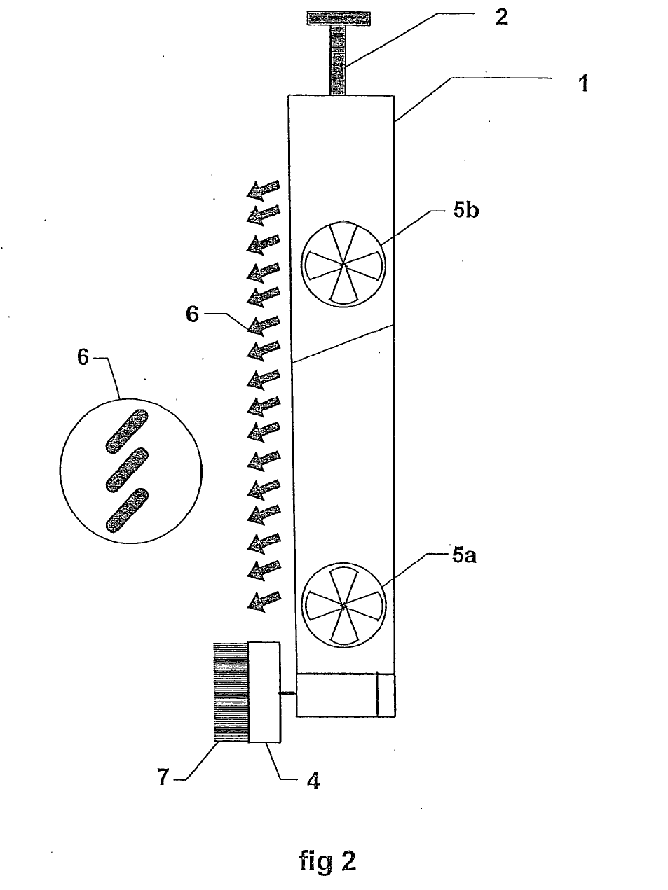

FIGS. 1 and 2 discloses a schematic view from the side of a hanging aggregate having activated nozzles for washing, chemicals, wax and drying. The aggregate is hanging from the frame of the vehicle wash;

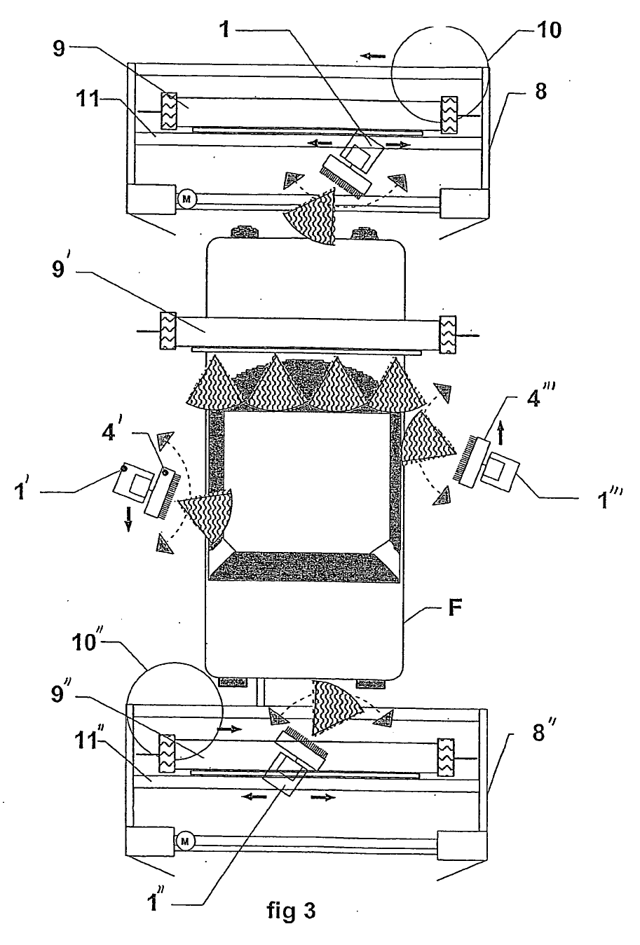

FIG. 3 discloses a schematic view from above of a hanging aggregate during a chemical/washing phase;

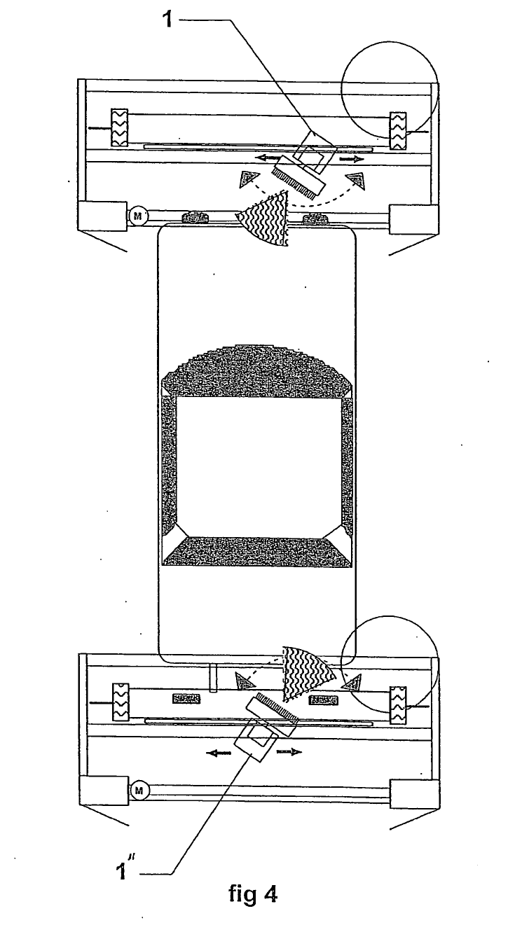

FIG. 4 discloses a schematic view from above of a hanging aggregate during drying of the front part and the back part of the vehicle respectively;

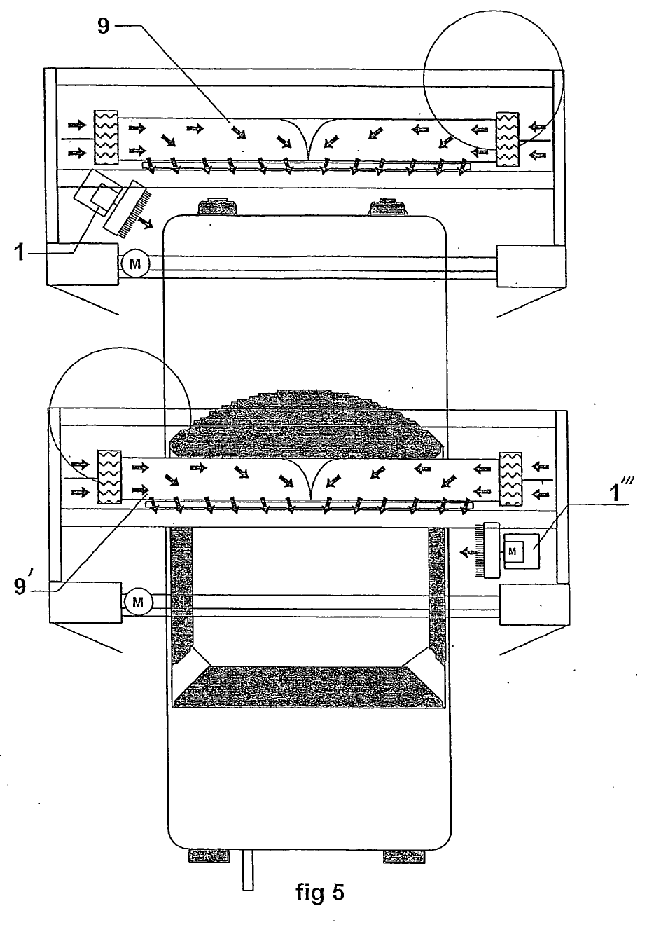

FIG. 5 discloses a schematic view from above of a hanging aggregate and an overhead ramp during the drying of the side part and roof part of the vehicle;

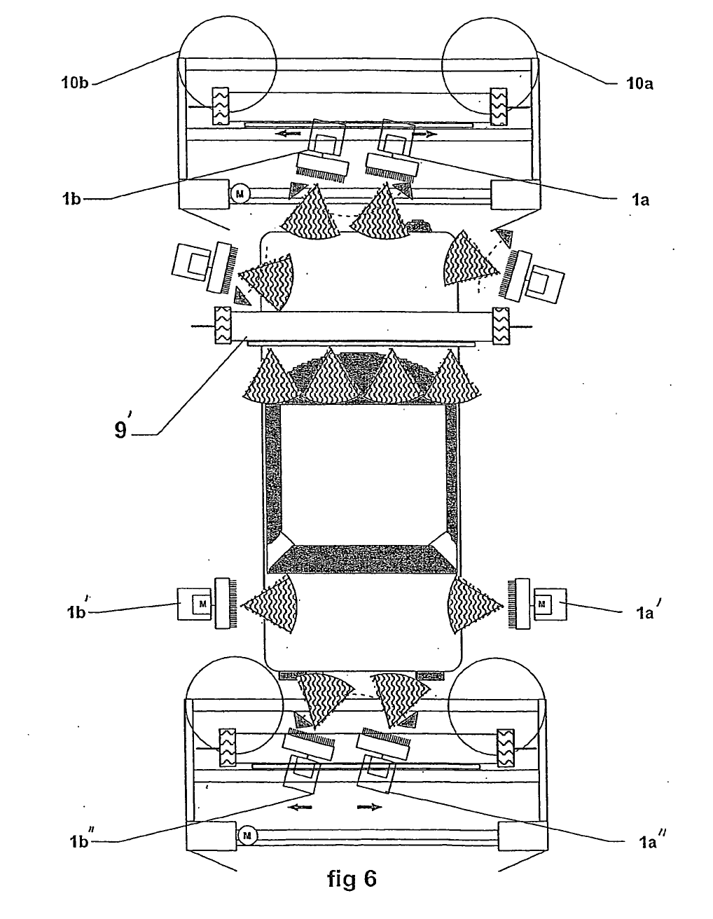

FIG. 6 discloses a schematic view from above of two hanging aggregates during the chemical/washing phase of the side part and roof part of the vehicle, compare FIG. 3;

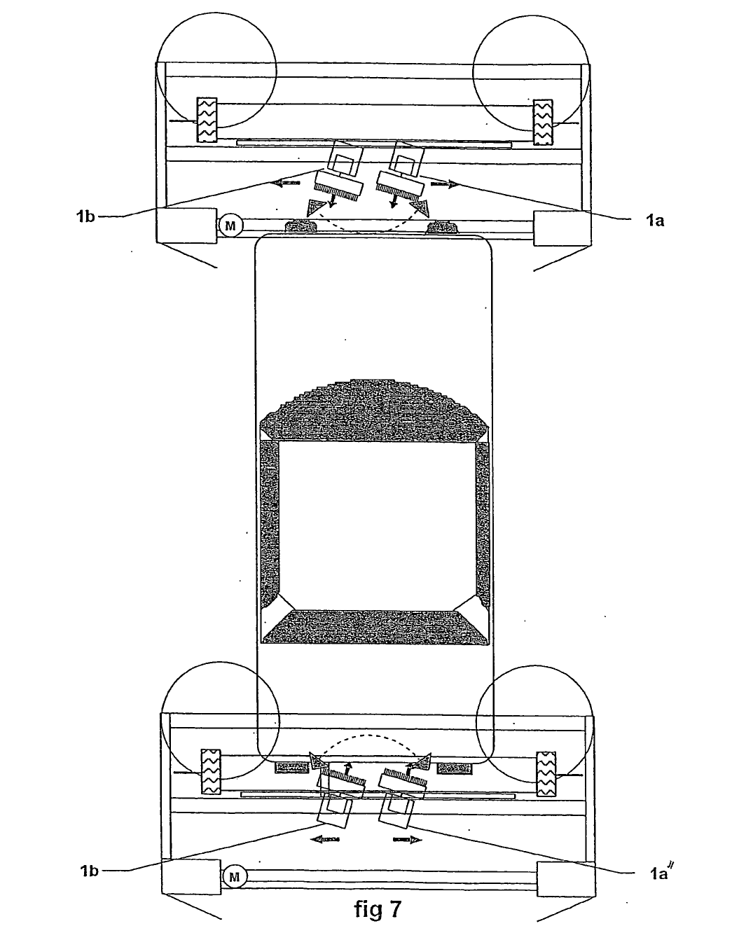

FIG. 7 discloses a schematic view from above of two hanging aggregates during the drying phase of the front part and back part of the vehicle, compare with 4;

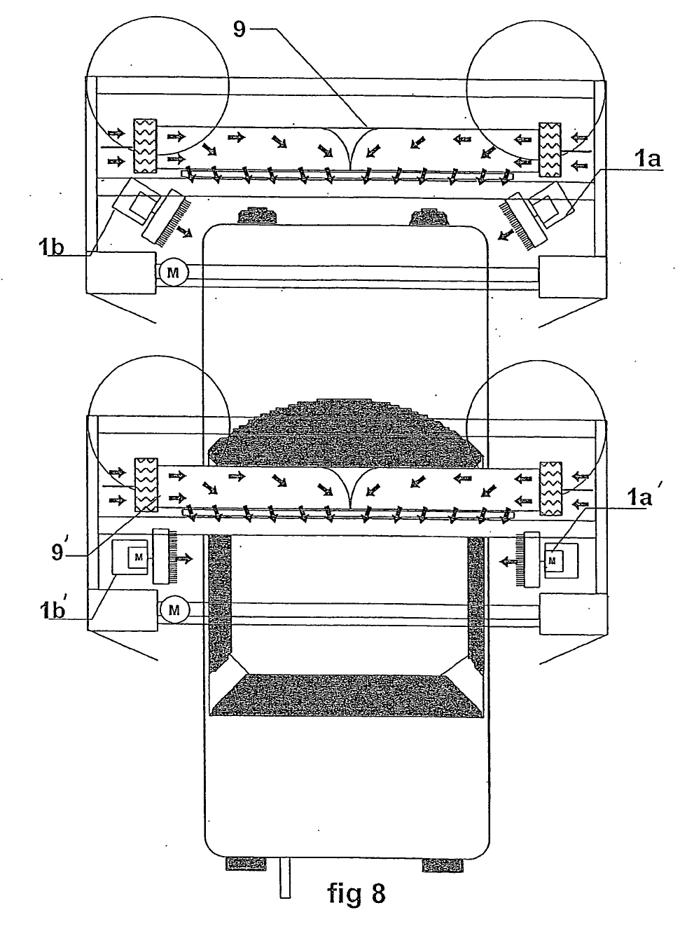

FIG. 8 discloses a schematic view from above of two hanging aggregates and an overhead ramp during the drying of the side part and roof part of the vehicle, compare FIG. 5.

In this context, vehicle means not only ordinary cars but also minibuses, so called vans etc.

By integrating all functions, i.e. washing, applying chemicals, waxing, drying and wheel cleaning, into one aggregate (shown in FIGS. 1 and 2) several advantages are obtained, such as simplified manufacturing process, transport and assembling to mention some. The invention also allows for a car wash to be expanded and up-graded to a higher capacity with increasing customer potential. Thus, it will be natural to for example a gas station, to first invest in a smaller, cheaper equipment that will be profitable with a most moderate capacity, and later up-grade this present equipment with further components and equipments. A satisfactory washing result with a simple technique will give a lower cost for each wash.

In FIGS. 1 and 2 is thus shown a schematic view from the side of a hanging aggregate 1 having activated nozzles 3a-3e for chemicals, wax and water respectively with activated drying means 5a, 5b. The aggregate 1 is supported by a carrier 2 in a not more specifically shown beam (shown in FIGS. 3-8), being frame mounted on the washing equipment, with which the aggregate 1 may be transferred in a track around a parked vehicle F in connection with washing, waxing and drying, which is shown more specifically in the FIGS. 3-8.

The carrier 2 is pendulum suspended in the beam having an emergency shutdown function (not shown), which will stop the equipment at a certain predetermined angel and will thus prevent that persons or equipment from being harmed or damaged.

A rotating wheel cleaning device 4 is shown at the bottom of the aggregate 1, which device 4 will be used especially for washing of toe recesses of the car and under the bumpers in the front and at the back and also for the wheel felloes. One in the wheel washing device 4 arranged brush 7 is active at the washing of the wheel felloes, but not at washing of toe recesses and bumpers. Integration of the wheel washing device 4 in the hanging aggregate 1 enables an optimal washing on the surfaces where the car is the dirtiest, e.g. under the bumpers in front and at the back.

By arranging the hanging aggregate 1 pivotally in such manner that it performs a oscillating lateral movement, a very effective dirt removing spray pattern will be formed over the surface of the vehicle, which is treated with the oscillating movement. Since the aggregate 1 is transferred simultaneously while the oscillating movement is going on, one and the same place on the surface of the vehicle will be treated with different angles, which will enhance the mechanical treatment from the nozzles 3a-3e. The same effect enhancement is obtained in the operation where the vehicle is flushed, is waxed and is dried. Through the inventive method, also the water and chemical consumption is decreased. How the aggregate 1 is pivoted to accomplish the oscillating movement is a suitable action taken of the person skilled in the art and will not be further discussed herein, e.g. may a shifting motor be used.

The drying air streams out of a slotted channel (partly shown as 6) mounted in the aggregate 1. The walls in the slotted channel are angled such that the air-streams 6 in a more effective manner removes the water, than they would do if they perpendicularly hit the surface that is being dried. Thus, the air-streams 6 are angled downwards towards the ground combined with an angle backwards somewhere between 30°-80° in relation to the direction of the movement of the aggregate 1. For the same reason, also the nozzles 3a-3e may be angled downwards and angled backwards to improve the removal of, e.g. flush dirt and the chemicals that are used at washing.

The aggregate 1 has two drying motors 5a, 5b, where at drying of ordinary low profile vehicles, such as passenger cars, only the lower motor 5b will be used and at drying of vehicles having a higher profile, such as vans, both of the motors 5a, 5b will be used. This leads to an optimal drying result on high vehicles and the consumption of electricity is decreased by simply adjusting the number of drying motors used to the height of the vehicle. In the same manner, it is possible to adjust the number of used nozzles 3a-3e at washing and waxing.

In FIG. 3 is shown a schematic view from above of a washing equipment comprising a supporting arrangement 8 and a top nozzle 9 at different positions under chemical/washing phase and under use of the present invention. The top nozzle 9 is thus shown in a position in front of, above 9′ and behind 9″ the vehicle F and the supporting arrangement is shown in a position in front of and behind 8″ the vehicle F. Further, in FIG. 3 is shown the aggregate 1 mounted on a beam 11 and the on the aggregate 1 mounted wheel washing device 4 in four different positions 1-1′″ and 4-4′″ respectively on each side of the vehicle F during wash. The aggregate 1 may be used separately or in combination with one or more brushes 10 arranged on the supporting arrangement 8. In the figure, the aggregates 1-1′″ shown in pivoted positions and marked with arrows how they are moved. The aggregate 1 is thus arranged on the beam 11 such that it runs along this. How this is arranged is a suitable action taken of the person skilled in the art and will not be further discussed herein, e.g. it may be arranged in a track or on a rail etc.

In FIGS. 4 and 5 views are shown during drying of a vehicle F that has been washed, whereby the aggregate 1 is used to dry the sides of the vehicle F and the top nozzle 9 is used to dry the roof of the vehicle F. In FIG. 5 is shown how the aggregate 1 is moved around the corner of the vehicle F during simultaneous outflow of drying air.

In FIG. 6 is shown a schematic view from above of an alternative washing equipment provided with two aggregates 1a, 1b having wheel washing devices 4a, 4b for washing of the four sides of the vehicle F. The in FIG. 6 shown equipment can thus perform washing, waxing and drying faster compared to that in FIG. 3 to FIG. 5 shown equipment and is an example of a simple equipment complemented in order to be more effective. In FIG. 6 is also shown two brushes 10a, 10b for use in combination with the aggregates 1a, 1b. Corresponding to FIGS. 4 and 5 is shown in FIGS. 7 and 8 how drying with two aggregates 1a, 1b is performed around the vehicle F.

In a second embodiment of the present invention the inventive method and aggregate are used in a polishing plant for vehicles. The inventive method and aggregate may also be used at washing, waxing and drying of containers, trucks, busses, caravans etc. The invention is thus not limited to the above mentioned embodiments, but may also be given other aspects within the scope of the following stated claims.

1. Aggregate to with at least one fluid jet remove from an exterior surface of a vehicle solid and liquid particles and where appropriate also increase the luster of the surface, wherein the aggregate comprises at least one nozzle to generate the jet, that the aggregate is arranged to move along the surface in a track around the parked vehicle during a simultaneous exercise of a pivotal movement to give the jet a substantially horizontally oscillating movement.

2. The aggregate according to claim 1, wherein the functions washing, flushing, waxing and drying are integrated in the aggregate.

3. The aggregate according to claim 1, wherein a washing device comprising a nozzle and a brush is arranged on the aggregate.

4. The aggregate according to claim 1, wherein the aggregate comprises at least a first and a second drying means, that the second drying means is arranged to only be used at drying of high vehicles and that the first drying means thus is arranged to be used at drying of both low and high vehicles.

5. The aggregate according to claim 1, wherein the nozzles are angled downwards towards the ground and backwards in relation to the direction of movement of the aggregate.

6. Equipment to with at least one fluid jet remove from an exterior surface of a vehicle solid and liquid particles and where appropriate also increase the luster of the surface, which equipment comprises a portal, which is running on both sides of the vehicle, on which a transverse beam is arranged, wherein at least one aggregate according to claim 1 is pivotally arranged running along the beam.

7. The equipment according to claim 5, wherein at the portal is arranged at least one brush, which is used in combination with the aggregate at treatment of the vehicle.

8. The eguipment according to claim 6, wherein the aggregate is pendulously suspended in the beam and has an emergency stop function, which stops the equipment at a predetermined angle.
